(19) United States
(12) Patent Application Publication
(10) Pub. No.: US 2010/0115444 A1
(43) Pub. Date: May 6, 2010

(54) Plot-Driven Measurement

(76) Inventor: James Adam Cataldo, San Jose, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 12/264,219

(22) Filed: Nov. 3, 2008

(51) Int. Cl. G06F 3/048

(52) U.S. Cl. 715/771

(57) ABSTRACT

Plot-driven measurement software for controlling an instrument. A capability of the instrument is displayed in a graphical user interface (GUI). A plot outline is also displayed in the GUI. The plot outline has a plot variable, to which a user can assign the capability. The plot outline is translated into an instruction set for the instrument to execute the capability. The data resulting from the instrument executing the capability is displayed on the plot outline.

### BACKGROUND

Test and measurement instruments need to be set up to make a measurement or generate an output, and to plot the results. This can be done by manually interacting with the physical instrument, such as turning a knob or pushing some buttons on the instrument itself. This manual interaction can become repetitive and time-consuming, so users find ways to automate the process.

One form of automation is to write software for controlling an instrument and analyzing the result. However, this approach requires programming expertise on the part of the user. The user must have sufficient knowledge of the relevant programming language (e.g. C, C++, C#, etc.) to write the proper commands in software.

Some visual programming languages exist that attempt to reduce the complexity involved in writing software for an instrument or system of instruments. For example, National Instruments sells a package called LabView, and Agilent Technologies, Inc. sells one called VEE. LabView and VEE are visual programming languages that represent a software program as a set of interconnected blocks. Users visually manipulate connections between the blocks to control the acquisition and analysis of data. When a sample program for a desired measurement/output and analysis has already been written in such a language, it is relatively simple for a user to make some modifications for an easy customization. However, if no sample program exists, the user must write her own program from scratch. This can be time consuming.

Therefore, it is desirable to reduce the time and difficulty involved with automating control of an instrument.

### BRIEF DESCRIPTION OF THE DRAWINGS

FIG. 1 shows an exemplary system in which plot-driven measurement may be used.

FIG. 2 shows an expanded view of a GUI in accordance with an embodiment of the present invention.

FIG. 3 is an expanded view of the area outlined by box 34 in FIG. 2

FIG. 4 is an updated version of the GUI of FIG. 2

FIG. 5 shows the GUI after an instrument has executed an instruction set.

FIG. 6 shows a GUI where capabilities of two different instruments are shown in the capability list.

FIG. 7 shows a GUI needing additional configuration.

FIG. 8 shows a GUI for measuring a derived quantity.

FIG. 9 shows a high-level block diagram for plot-driven measurement software.

FIG. 10 shows a flowchart for a method for plot-driven measurement.

### DETAILED DESCRIPTION

Plot-driven measurement software allows a user to control a test and measurement instrument via interaction with a graphical user interface (GUI). A user indicates on a plot outline in the GUI what measurement should be executed to acquire data. The plot outline is translated by the software into a instruction set to the instrument, which carries out the instruction set to execute the measurement and acquire the desired data. The resulting data is displayed on the plot outline. In this manner, the user can control an instrument without needing any special visual or textual programming knowledge.

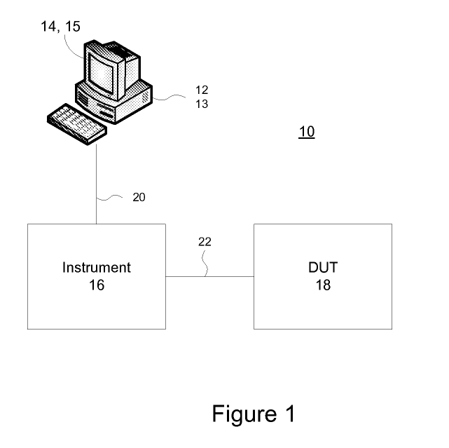

FIG. 1 shows an exemplary system 10 in which plot-driven measurement software may be used. The system 10 includes a computer 12 (or any other processing device) that runs plot-driven measurement software 13, a display 14 that displays a GUI 15 for the plot-driven measurement software, an instrument 16, and a device under test (DUT) 18.

The plot-driven measurement software 13 on computer 12 sends instructions to and receive messages and/or data from the instrument 16 via a communication channel 20. The instrument 16 acquires data from or generates signals to the DUT 18 through a test channel 22. Communication channel 20 and test channel 22 may be physical connections (e.g. cables or wires) or wireless connections. Although the computer 12, display 14, and instrument 16 are shown as separate distinct devices in the figure, any of the devices can be integrated with the others. For example, the computer 12, display 14, and instrument 16 may all be integrated as one device. The display 14, computer 12, instrument 16, and DUT 18 may also be separate devices in completely different locations. Although FIG. 1 only shows one instrument 16 in communication with the computer 12, the computer 12 may be in communication with more than one instrument at a time.

The capabilities of the instrument 15 which will depend on the type of instrument used. For example, if the instrument 15 is a digital multimeter, its capabilities include measuring the voltage, current, resistance, etc. of the DUT 18. If the instrument 15 is a signal generator, its capabilities include generating sine waves, square waves, modulated waveforms, etc. to send to the DUT 18. These two instruments are listed as examples only—any other instrument having capabilities compatible with the plot-driven measurement software 13 may also be used. Such instruments include, but are not limited to: digital multimeters, function generators, network analyzers, spectrum analyzers, power supplies, frequency counters, RF signal generators, mass spectrometers, DNA microarray scanners, chromatographs, and other instruments that generate or acquire data that may need to be plotted.

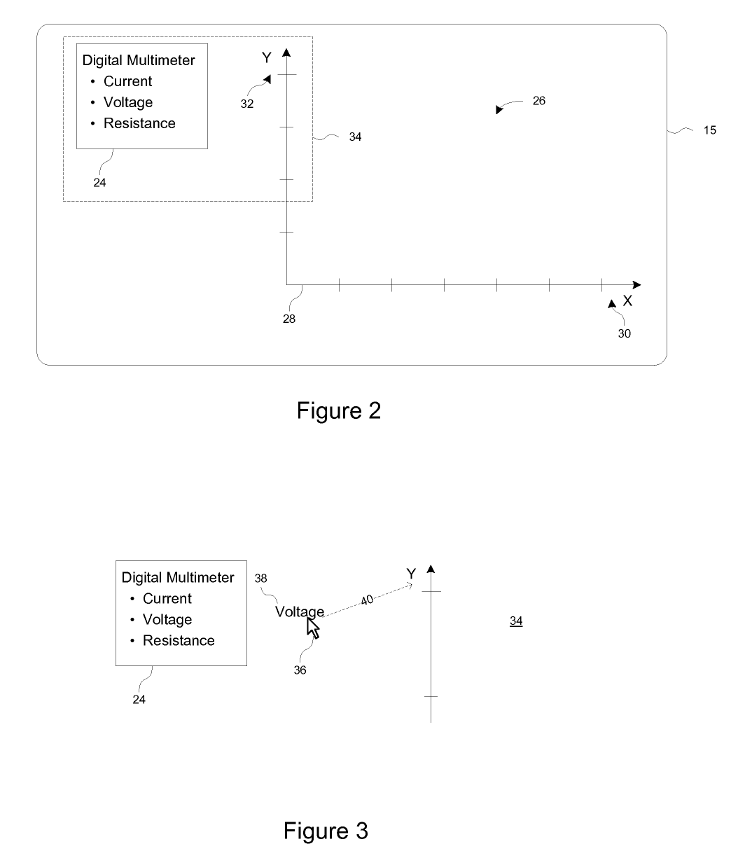

FIG. 2 shows an expanded view of the GUI 15 in accordance with an embodiment of the present invention. The GUI 15 is the user interface for the plot-driven measurement software 13. The GUI 15 includes a capability list 24 and a plot outline 26. The capability list 24 lists capabilities of the instrument 16. In the example shown, the instrument is a digital multimeter, having the listed capabilities of measuring current, voltage, and resistance. Information regarding the capabilities of the instrument 16 can be provided by the manufacturer of the instrument 16, or a third party having knowledge of the capabilities of the instrument. Such information can even be provided by the user of the instrument 16.

The plot outline 26 is an empty plot frame that initially has no data showing. The plot outline 26 includes at least one plot variable also displayed on the plot outline 26. In the example of FIG. 2, the plot outline 26 is a graph 28 having two plot variables: an X-axis 30 and a Y-axis 32. The graph 28 could be the basis for plotting data as a line graph, a bar graph, area graph, etc. Other kinds of plot outlines can be used as well, for example, 3D graphs, a pie charts, histograms, a Venn diagram, etc.

A user needs to assign values to the plot variables on the plot outline 26 to make a measurement with the instrument 16. In the example of FIG. 2, the Y-axis will typically be assigned a capability from the capability list 24, and the X-axis will typically be assigned a range of values over which to measure the capability. However, it should be obvious that the roles of the Y-axis and X-axis could easily be reversed.

For example, suppose a user wishes to measure the voltage at the DUT 18 over time. To the Y-axis of the graph 28, the user would assign the capability of “Voltage” as shown in the capability list 24. To the X-axis of the graph 28, the user can assign a range of time over which the desired measurement should take place, e.g. 0-60 seconds. Or, the time range can be left open to obtain an ongoing measurement.

The assignments of values to the plot variables can be done in various ways. In one embodiment, the user can click and drag selected capabilities from the capability list 24 onto the desired plot variable to make the assignment. Refer to FIG. 3, which is an expanded view of the area outlined by box 34 in FIG. 2. A user manipulates a pointer 36 in the display to select (e.g. “click”) a capability 38 from the capability list 24. For the purposes of this example, the capability 38 will be “Voltage”. Using the pointer 36, the user “drags” the capability 38 in the direction of arrow 40 onto the plot variable Y-axis to indicate on the plot outline 26 that a measurement of Voltage is desired. The assignment of a capability to the X-axis can be accomplished in the same manner. Additional configuration may also be needed when a capability is assigned to an axis. For example, a range of values (e.g. for the X-axis) may need to be specified. The software can prompt a user to enter a range of values, or the user may specify the range unprompted.

It should be obvious to one of ordinary skill in the art that there are many other ways to assign values to the plot variables in the plot outline 26. For example, the user could select from a pull-down menu of available options to assign a capability to the plot variable in question. The user can also directly type in the desired value to the plot variables, using a keyboard or other data input device. The user could also write the capability on the plot with a mouse and keyboard combination, or with a stylus. In such an example, the plot-driven measurement software 13 would need to include character recognition to link a variable to a capability. Instead of assigning the capability within the GUI 15, the user could also specify the equivalent plot outline in a command line, in a plot-driven measurement programming language, or as calls to functions in an existing programming language.

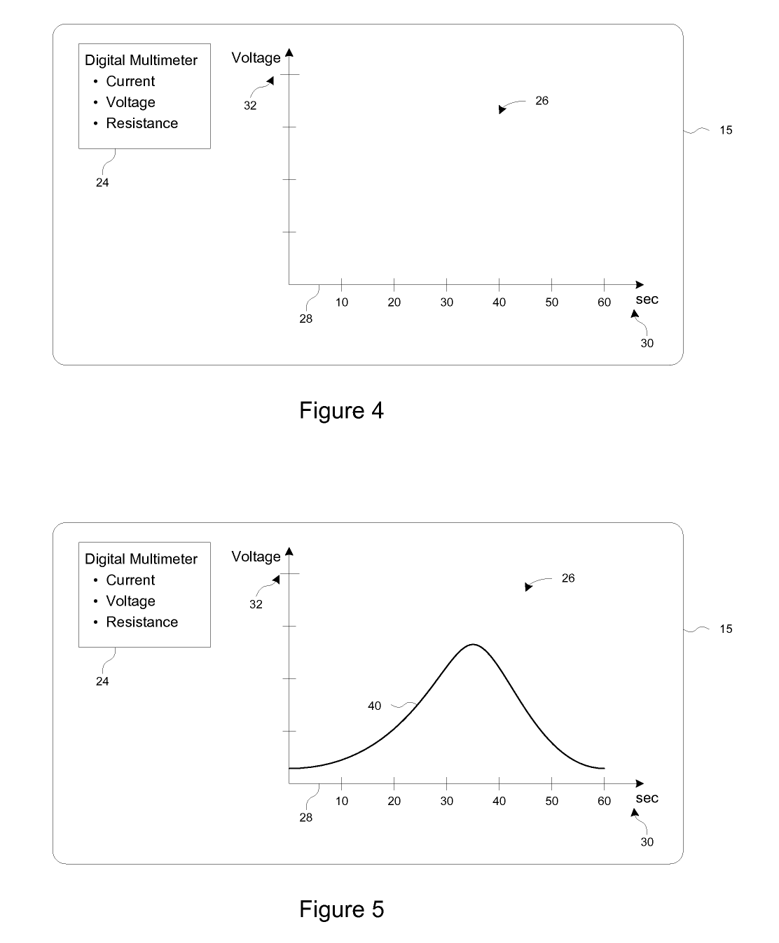

FIG. 4 is an updated version of the GUI 15 of FIG. 2, after a user has assigned values to the plot variables in the plot outline 26. The Y-axis is now assigned to the capability “Voltage”, and the X-axis has been assigned a range of 0 to 60 seconds.

Once the user has assigned the needed values to the plot variables, the plot outline 26 and its variable values are translated into an instruction set that is sent to the instrument 16 via the communication channel 22 (seen in FIG. 1). The instruction set includes any instructions needed to configure the instrument 16 to carry out the capability.

Translating the plot outline 26 into an instruction set requires a mapping between a capability of the instrument 16, and the instructions needed to configure and execute the capability. Table 1 below shows an exemplary table mapping between some capabilities of a digital multimeter instrument and its respective instructions for configuration and execution.

TABLE 1

| Capability | Instruction |
|---|---|
| Current | CONFigure: CURRent: DC <range>[, <resolution>] |
| Voltage | CONFigure: VOLTage: DC <range>[, <resolution>] |
| Resistance | CONFigure: RESistance <range>[, <resolution>] |

The examples in Table 1 follow the Standard Commands for Programmable Instrumentation (SCPI) format. The parameters to each command are shown between the angle brackets. The parameters between square brackets are optional. Also, although only a single command is shown per capability in Table 1, there may be multiple commands associated with each capability. Such a mapping can be provided by the manufacturer of the instrument or a third party having knowledge of the instruments capabilities. A mapping can also be generated by the user of the instrument 16. The syntax of instructions for a particular instrument are highly instrument-dependent, so the instructions shown in Table 1 are purely exemplary.

The instrument 16 receives the instruction set from the computer 12 and executes the instruction set. The data gathered by the instrument 16 from executing the instruction set is sent back to the computer 12 and the plot-driven measurement software 13. The plot-driven measurement software 13 fills in the plot outline 26 with the gathered data.

FIG. 5 shows the GUI 15 after the instrument 16 has executed the instruction set. Data 40 received from the instrument executing the instruction set is plotted on the plot outline 26. This data 40 can be plotted as the instrument gathers the data. If it is clear to the user that the intermediate results shown on the plot outline are wrong, then the measurement can be canceled by the user without completing the plot.

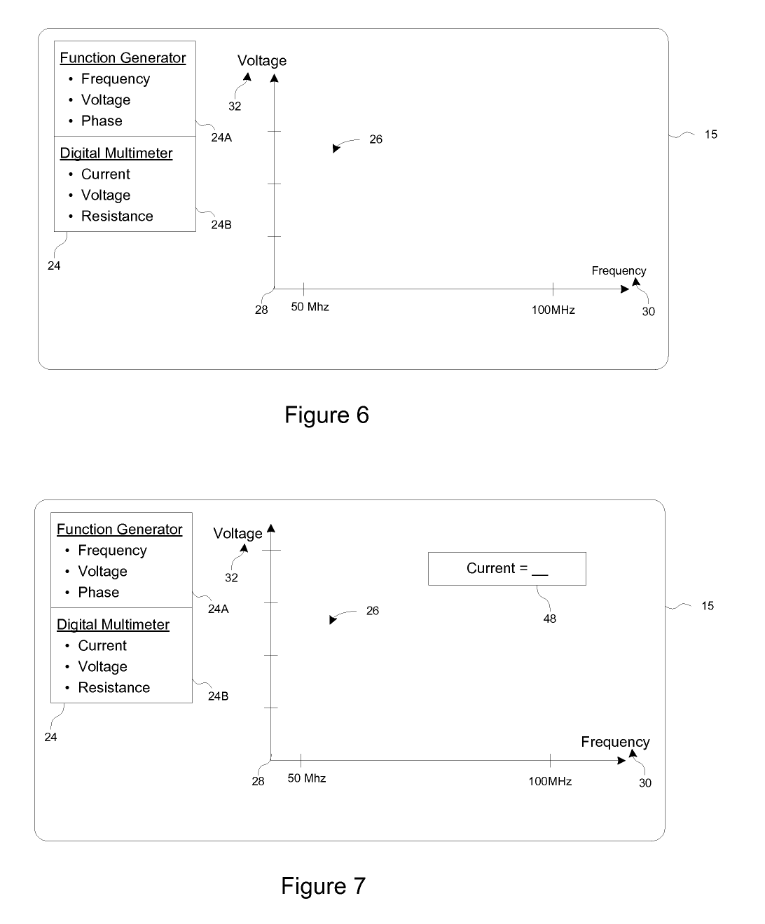

More than one instrument can be controlled using plot-driven measurement software. FIG. 6 shows a GUI 15 where the capabilities of two different instruments are shown in the capability list 24. List 24A lists the capabilities of a function generator, which include generating waveforms having a specified frequency, voltage, or phase. List 24B lists the capabilities of the digital multimeter as previously described.

In the exemplary plot outline 26 of FIG. 6, the X-axis 30 has been assigned the capability “Frequency” from the function generator list 24A. The range of frequency values over which to collect data has been entered as 50 Megahertz (MHz) to 100 MHz. The Y-axis 32 has been assigned the capability “Voltage” as in the previous example.

When this plot outline 26 is translated into an instruction set, instructions are generated for both the function generator and the digital multimeter. The instructions for the function generator will instruct it to sweep in values from 50 MHz to 100 MHz. The instructions to the digital multimeter will tell it to measure voltage of the DUT 18 at a given frequency of the function generator. The results of such a measurement are also plotted on the plot outline 26.

Some instrument capabilities may have or need additional setup or configuration beyond what is indicated by the plot variables on a plot outline. Such additional configuration can be handled by allowing the user to enter additional input with a configuration prompt. FIG. 7 shows a GUI 15 where the current needs to be set before making a voltage reading. A configuration prompt 48 appears in the GUI 15 that prompts a user to fill in the desired quantity for the current before the measurement can be made. The configuration prompt 48 is shown as a text-entry box or label on the plot outline 26, but the configuration prompt 48 can appear anywhere on the GUI 15 and in any form suitable for data input. In one embodiment, the configuration prompt 48 can be toggled between visible and hidden modes, so that a user can choose between viewing configuration options or to reducing visual clutter on the GUI 15. This is especially useful if a lot of additional configuration information can be entered for a given capability. The toggling can be controlled through a menu for the GUI 15 (not shown).

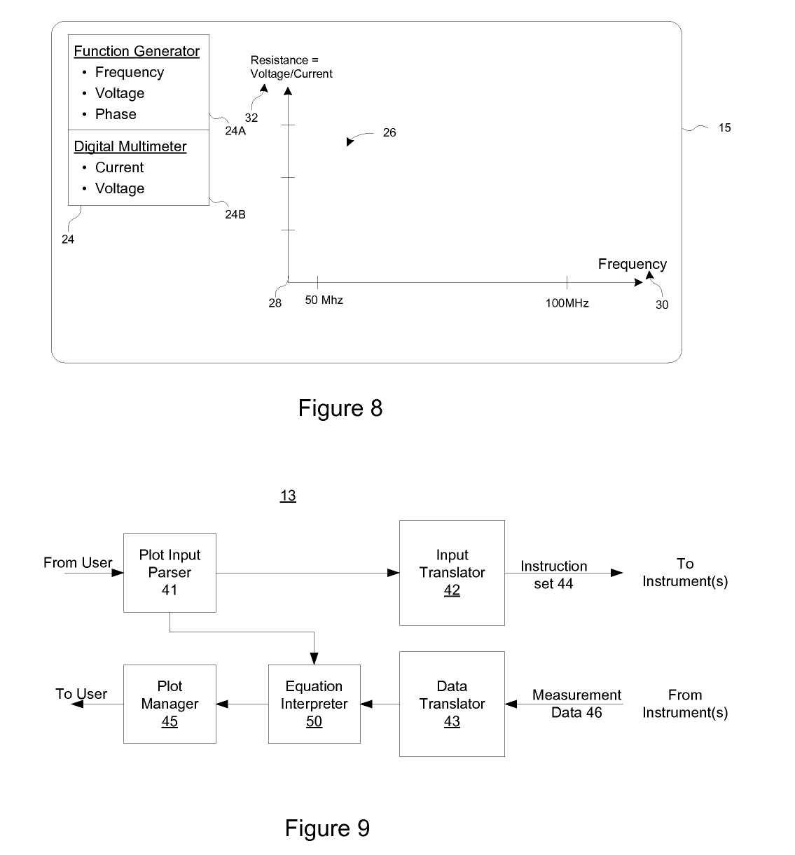

Derived quantities that are not listed as instrument capabilities can also be measured. FIG. 8 shows a GUI 15 for measuring a derived quantity. Suppose a user would like to measure resistance, but the capability list 24 does not include resistance as a measurable capability. However, capability list 24B does indicate that the digital multimeter can measure current and voltage. So, instead of assigning a single capability to the Y-axis 32, the user can assign an equation consisting of the voltage capability divided by the current capability of the digital multimeter. When the plot outline 26 is translated, the instruction set will include instructions to the digital multimeter to measure both the voltage and the current. When the data for the voltage and current is returned, the plot-driven measurement software will calculate resistance by dividing the voltage values by the current values before displaying the result on the plot outline.

FIG. 9 shows a high-level block diagram for the plot-driven measurement software 13. The plot-driven measurement software 13 includes a plot input parser 41, an input translator 42, a data translator 43, an equation interpreter 50, and a plot manager 45.

A user fills in a plot outline 26 with the capabilities and configuration desired from the instrument(s). The plot input parser 41 extracts the capabilities and configuration data entered by the user, and sends it to the input translator 42.

The input translator 42 translates the capabilities and configuration data into an instruction set 44 that is sent to the instrument(s). The input translator 42 utilizes an instruction mapping, such as the example of Table 1, to generate the instruction set 44. The instruction set 44 contains the instructions needed to configure and execute the instrument capabilities selected by the user in the plot outline 26. The instruction set 44 is sent to the instrument(s) for execution. If the capability and configuration data extracted from the plot outline 26 includes a user-created equation as described in FIG. 8, that equation information is sent to an equation interpreter 50.

The data translator 43 receives measurement data 46 from the instrument(s) executing the instruction set 44. The data translator 43 translates the measurement data 46 into internal programming data for displaying the measurement data 46 in the GUI 15. The output of the data translator 43 is sent to the equation interpreter 50, which performs the mathematical calculations necessary to generate the results of any user-created equations, if needed.

The plot manager 45 manages the display seen by the user in the GUI 15. It plots the measurement data received from the instrument(s), or the results of a user-created equation calculated on the measurement data.

The plot-driven measurement software 13 can be written using almost any programming language, including but not limited to: C, C++, Java, C#, Visual Basic, Matlab, and LabVIEW. The software 13 can interface with other software programs. For example, software programs such as National Instruments Max (available from National Instruments Corporation) and Agilent Connection Expert (available from Agilent Technologies, Inc.) allow connected instruments to be automatically detected by the computer. The plot-driven measurement software 13 can utilize such available software to present the available instruments to the user. The software 13 can be stored on any computer-readable medium, including but not limited to: compact disk (CD), digital video disc (DVD), memory card, hard disk drive.

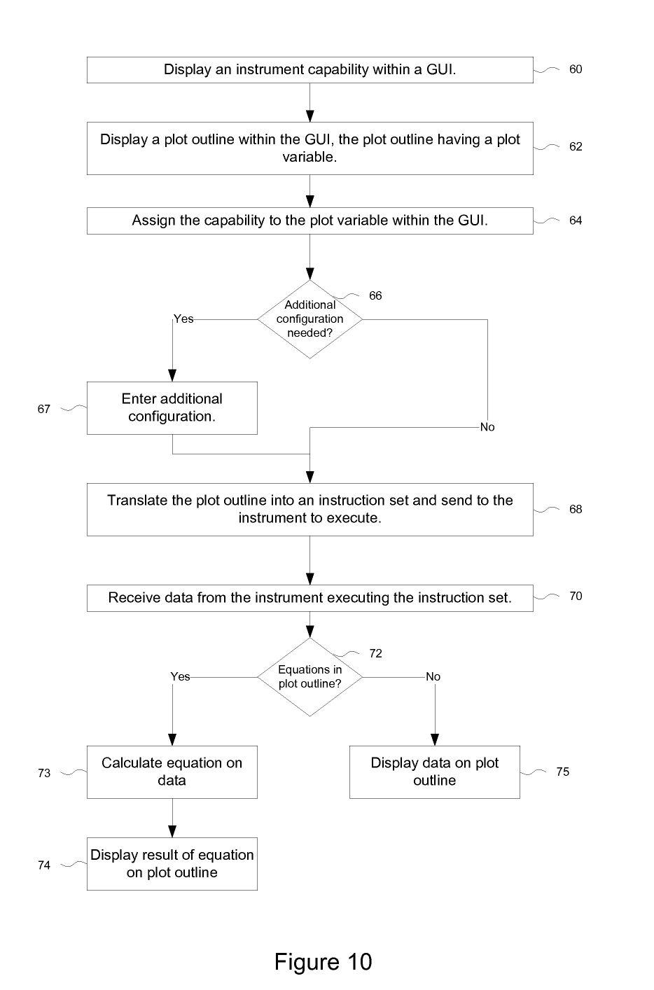

FIG. 10 shows a flowchart for a method for plot-driven measurement. The steps in the flowchart are numbered for ease of reference only, and do not need to be performed in the order listed.

In step 60, display an instrument capability within a GUI.

In step 62, display a plot outline in the GUI, the plot outline having a plot variable. The plot outline can include, but is not limited to: graphs (2-D, 3-D, etc), pie charts, etc. The plot variable can include, but is not limited to: an axis of a graph.

In step 64, assign the capability to the plot variable within the GUI. This can be done in the GUI by a user. For example, the user can manipulate a pointer within the GUI to “click-and-drag” the capability onto the plot variable. Assigning a capability can also include assigning an equation containing the capability.

In step 66, determine if any additional configuration is needed to execute the capability. If additional configuration is needed, continue to step 67. If no additional configuration is needed, then continue to step 68.

In step 67, enter any additional configuration. For example, if a range of values is needed, or if a setup parameter is needed, it should be entered.

In step 68, translate the plot outline (including any additional configuration, if needed) into an instruction set and send to the instrument to execute. The translation can be done by referencing an instruction mapping which maps a capability of an instrument to the necessary instructions to configure and execute the capability.

In step 70, receive data from the instrument resulting from executing the instruction set.

In step 72, determine whether any equations were entered into the plot outline. If there were equations entered, then continue to step 73. If no equations were entered then continue to step 75.

In step 73, if equations were entered into the plot outline, calculate the equation using the data received.

In step 74, display the results from calculating the equation in step 73.

In step 75, if no equations were entered into the plot outline, then display the data as received from the instrument on the plot outline.

Although the present invention has been described in detail with reference to particular embodiments, persons possessing ordinary skill in the art to which this invention pertains will appreciate that various modifications and enhancements may be made without departing from the spirit and scope of the claims that follow.

What is claimed is:

1. A computer-readable medium having computer-readable instructions stored thereon for execution by a processor to perform a method for controlling an instrument, comprising:
displaying a capability of the instrument in a graphical user interface (GUI);
displaying a plot outline in the GUI, the plot outline having a plot variable;
allowing the capability to be assigned to the plot variable within the GUI;
translating the plot outline into an instruction set for the instrument to execute the capability;
displaying data on the plot outline resulting from the instrument executing the capability.

2. A computer-readable medium as in claim 1, wherein assigning the capability includes:
allowing a user to drag the capability onto the plot outline using a pointer within the GUI.

3. A computer-readable medium as in claim 1, wherein the plot outline is a graph and the plot variable is an axis of the graph.

4. A computer-readable medium as in claim 3, wherein the plot outline includes:
a first axis which indicates the capability to execute; and
a second axis which indicates a range of values over which to execute the capability.

5. A computer-readable medium as in claim 4, wherein the second axis includes a second capability for a second instrument.

6. A computer-readable medium as in claim 1, further comprising:
displaying a visual prompt for a configuration parameter to be entered, prior to translating the plot outline into an instruction set.

7. A computer-readable medium as in claim 1, wherein:
allowing the capability to be assigned to the plot variable includes allowing an equation to be assigned to the plot variable, wherein the equation includes the capability; and
displaying data on the plot outline includes displaying results from calculating the equation.

8. A graphical user interface in a display, comprising:
a plot outline having a plot variable;
a measurement capability of an instrument that can be assigned to the plot variable, wherein the assignment of the measurement capability to the plot variable is interpreted as an instruction to the instrument to measure data.

9. A graphical user interface as in claim 8, wherein the plot outline is a graph and the plot variable is an axis of the graph.

10. A graphical user interface as in claim 9, wherein each axis of the graph is assigned to a capability from a different instrument.

11. A graphical user interface as in claim 9, wherein the measurement capability can be clicked and dragged onto the plot outline by a pointer.

12. A graphical user interface as in claim 8, further comprising: a visual prompt for a configuration parameter to be entered

13. A method for controlling an instrument, comprising:
assigning a capability of the instrument to a variable of a plot to create a plot outline;
translating the plot outline into an instruction set for the instrument to execute the capability;
displaying data in the plot outline resulting from the instrument executing the capability.

14. A method as in claim 13, further comprising:
displaying the capability in a graphical user interface (GUI); and
displaying the plot outline in the GUI.

15. A method as in claim 14, wherein assigning the capability includes:
dragging the capability onto the plot outline using a pointer within the GUI.

16. A method as in claim 14, wherein the plot outline is a graph and the variable is an axis of the graph.

17. A method as in claim 16, wherein the plot outline includes:
a first axis which indicates the capability to execute; and
a second axis which indicates a range of values over which to execute the capability.

18. A method as in claim 17, wherein the second axis includes a second capability for a second instrument.

19. A method as in claim 14, further comprising:
displaying a visual prompt for a configuration parameter to be entered, prior to translating the plot outline into an instruction set.

20. A method as in claim 14, wherein:
assigning the capability to the variable includes assigning an equation to the variable, wherein the equation includes the capability; and
displaying data on the plot outline includes displaying results from calculating the equation.
